(19) United States
(12) Patent Application Publication
(10) Pub. No.: US 2006/0275914 A1
(43) Pub. Date: Dec. 7, 2006

(54) Toxic agent sensor and detector method, apparatus, and system

(75) Inventors: Don Henley, Denton, TX (US); Aman Anand, Denton, TX (US); Tim Imholt, Richardson, TX (US); James Roberts, Krum, TX (US)

Correspondence Address: T. Ling Chwang, Suite 6000, 901 Main Street, Dallas, TX, 75202, US

(73) Assignee: University of North Texas, Denton, TX (US)

(21) Appl. No.: 11/440,665

(22) Filed: May 25, 2006

Related U.S. Application Data
(60) Provisional application No. 60/684,289, filed on May 25, 2005.

(51) Int. Cl. G01N 24/00

(52) U.S. Cl. 436/171

(57) ABSTRACT

A method, apparatus and system for use in sensing and detecting various biological and chemical agents. More specifically, the present invention utilizes nanotubes as a novel structure in a particle detection application. Antibodies for agents such as anthrax, bubonic plague, e-coli, botulism, small pox and fast spreading viruses such as SARS are homogeneously dispersed on a nanotube filter such as a CNT filter, including buckypaper. These filters are then placed into a device which facilitates filtering volumes of the atmosphere or food material. Any pathogen or toxin corresponding to the specific antibody held by the nanofilter reacts with the antibody and are retained on the filter. The nanofilter would then be subjected to microwave treatment and spectral analysis.

### RELATED APPLICATIONS

This application claims priority to U.S. Provisional Patent Application, Ser. No. 60/684,289, entitled “TOXIC AGENT SENSOR AND DETECTOR METHOD, APPARATUS AND SYSTEM” filed on May 25, 2005, having Imholt et al., listed as the inventor(s), the entire content of which is hereby incorporated by reference.

### STATEMENT OF RIGHTS TO INVENTIONS MADE UNDER FEDERALLY SPONSORED RESEARCH

No federal grants or funds were used in the development of the present invention.

### BACKGROUND

The present invention relates to a method, sensor, and apparatus for detecting toxic materials in a volume of atmosphere. More specifically, the method of detecting an antigen or chemical species of interest in a volume of atmosphere, is accomplished by exposing a sensor to a volume of an atmosphere; irradiating the exposed-sensor with microwave radiation under vacuum conditions; and detecting a resonant profile of the exposed-sensor with microwave radiation. The sensor of this invention is capable of interacting with any chemical or biochemical species of interest that is contained in the volume of the atmosphere. In one preferred embodiment, the nanotube filter is linked to a functional group or antibody that capable of interacting with the nanotube forming an exposed-sensor that has a particular resonant profile when exposed to microwave radiation.

Since the Sep. 11, 2001 attacks on the United States, the problem of terrorism has petrified the entire world. There have been new standards established to scale the terrorist activities since that time. Military, Intelligence agencies, NSA, FBI and many other law enforcement agencies have been involved in executing plans that will enhance the security of the United States, as well as, several other international bodies. In the past decade or so there have been many incidents of terrorist attacks both inside and outside the United States that has concerned the government worldwide. Quoting directly from the (Military Guide to Terrorism in the Twenty first Century): “Despite the consistent menace, terrorism is a threat that is poorly understood, and frequently confused due to widely divergent views over exactly what defines terrorism.” The focus of this application is towards the threat posed by terrorism involving chemical and biological (CBD) attacks. Combating terrorism is not only a priority for FBI, NSA, DOD and other security agencies, but also a challenge to industries, academic researchers, as well as, scientists worldwide. The invention described herein is directed toward the detection of chemical and biological agents capable of mass destruction of human lives and disruption of civilization. There are several industrial toxins, as well as, other designer toxins that have been employed as weapons of mass destruction (WMDs) and known to many terrorist organizations worldwide. Detection of their chemical precursors as well as the CBDs themselves, poses a great challenge to security and combat teams worldwide. Many kinds of technologies have been developed in order to counteract these terrorist threats.

A Microwave Resonant Cavity, when phase locked to an electronic circuit and capable of oscillating in a broad GHz frequency range, becomes a highly sensitive device and can be used to detect toxin gases in microseconds, thus enabling the law enforcement agencies to carry out the necessary emergency activities. Since the operational state of the system is in the Gigahertz frequency range, the resulting sensitivity of the equipment allows measurement of toxins in the parts per billion (ppb) range.

Development of a highly sensitive microwave circuitry, and its wide usage in the Military institutions have already been in use since 1950s. These cavities, however, have not been adapted for use detecting toxic materials. Since 2000, many types of sensors have been developed. These are largely based upon the application of nanotechnology or polymers. No evidence of microwave resonant cavity application to detect toxic gases and other toxic compounds has been found. The usage of microwave resonant cavities loaded with both functionalized and non-functionalized nanomaterials to detect the toxic compounds and drugs is described herein.

Nanotechnology is the field of building structures at the scale of individual atoms. Nanotubes comprise the dominant subject matter of research in this area. Nanotubes are very small, typically 50 nanometers (“nm”) and smaller, structures that are essentially seamless pipes of one type of material or another. Carbon nanotubes (“CNTs”) comprise rolled up carbon sheets that form seamless ‘pipes’ on the scale of 1 to 100 nm in diameter. Since the initial discovery of multi-walled carbon nanotubes (“MWNT”) in 1991, CNTs have been observed in many forms. However, there are two primary structures. MWNT basically comprise a pipe within a pipe. The first MWNTs were made up of 2 to 50 concentric layered graphitic pipes having diameters in the range of 10 to 100 nm. This area of materials synthesis eventually led to the discovery of CNTs with only one layer. Single walled CNTs (“SWNT”) comprise a single layered carbon pipe. SWNTs are much thinner in diameter than MWNTs, with diameters in the range of 0.5 to 2.5 nm, and lengths up to the millimeter range.

The synthesis methods of MWNTs and SWNTs previously tended to yield very small (less than a gram) of material per day and were based on the same process which produced the C₆₀ molecule (also known as the fullerene which was initially observed 1985). In fact, all of these structures have many similar properties to the fullerene molecule. There are also now several synthesis methods which can yield many grams per day of CNT material. The characteristics and properties of SWNTs are actually closer to that of the fullerene molecule than that of the MWNT, causing them to be referred to as buckytubes from time to time. As described herein and in the literature, CNT refers to all carbon nanotubes be they SWNTs or MWNTs.

Purified SWNTs are the most useful form of CNT material, especially purified SWNTs that have been made into thin film form. The production process of carbon nanotubes typically results in impure nanotubes. Typically the impurities in these samples are non-nanotube forms of carbon and leftover catalyst materials. Typically catalyst materials used in the synthesis of SWNTs consist of metallic nano-particles such as but not limited to iron. Various purification methods are used which typically involve oxidation of samples as well as sonication in various liquids. These purification methods, while varied in nature, each serve to remove non-nanotube materials from the sample. If the exterior of the nanotube does not have any nano-particle sized residue clinging to the sides, it permits the nanotube to have electromagnetic properties for use in device applications.

Research on these structures has proliferated and numerous experimental, as well as theoretical simulation studies have been reported. Notable results include verification that CNTs can be either semiconducting or metallic in nature. The electronic properties of CNTs continue to be thoroughly investigated. Individual nanotubes can be either conductors or semiconductors and in some cases devices such as transistors have been made from single nanotubes.

There have also been several reports of SWNTs being used in sensors of various types, including biological agent sensors and microwave resonant frequency shift sensors for ammonia. These sensors, already in the field in some cases, utilize the natural resonant shifts of SWNT membranes detected by a resonant circuit to wirelessly send information about the condition of food in shipping. This is a significant sensing application as food spoilage during shipping is an economic and health issue. The ability to quickly identify problems in the environmental controls of the shipping vessel helps reduce costs, quickly and efficiently. This same principle applies to working with biohazards. If the origination point of a bio-hazard can be quickly and accurately triangulated, hazardous material cleanup crews can be deployed to ground zero quickly to eliminate the spread of disease. There have been many sensor designs for sensors based on nanotechnology. These conventional sensors are comprised of MWNTs and silicon dioxide. These materials are deposited onto a planar inductor-capacitor resonant circuit which monitors the materials and is able to determine according to the resonant conditions if there is carbon dioxide, oxygen, or ammonia present in the area of the sensor.

In addition, the following references discuss some usage of the RF technologies in designing toxin gas sensors: “A Novel Acoustic Gas and Temperature Sensor,” Jason D. Sternhagen et. Al., IEEE Sensors Journal, 2(4), (2002); “Modeling of Double Saw Resonator Remote Sensor,” M. Binhack et. al., IEEE 1416-2003 Ultrasonic Symposium, (2003); “The RF-Powered Surface Wave Sensor Oscillator—A Successful Alternative to Passive Wireless Sensing,” Ivan D. Avramov, IEEE Transactions on Ultrasonic, Ferroelectrics, And Frequency Control, 51 (9), (2004); Optimization of Gas-Sensitive Polymer Arrays Using Combinations of Heterogeneous and Homogeneous Subarrays,” D. M. Wilson, IEEE Sensors Journal, 2(3), (2002); “Effects of Electrode Configuration on Polymer Carbon-Black Composite Chemical Vapor Sensor Performance,” Brian matthews et. al. IEEE Sensors Journal 2(3), PP. 160. (2002); “Gas Sensitivity comparison of Polymer Coated SAW and STW Resonators Operating at the Same Acoustic Wave Length,” Ivan D. Avramov et. al, IEEE Sensors Journal, 2(3) PP. 150, (2002); “Carbon Nanotube—based resonant circuit sensor for ammonia,” S. Chopra et. al, Applied Physics letters, 80(24), (2002); “Gas Molecule adsorption in carbon nanotubes and nanotube bundles,” Jijun zhao, Alper Buldum, Jie Han, Jian Ping Lu, Nanotechnology, 13, PP. 195-200, (2002); “Nanosignal Processing: Stochastic Resonance in Carbon Nanotubes That Detect Subthreshold Signals,” Ian Y. Lee, Xiaolei Liu, Bart Bosko, Chongwu Zhou, NanoLetters, 3(12), PP. 1683-1686 (2003); “Three Dimensional polymer MEMS with functionalized Carbon Nanotubes and modified organic electronics,” Vijay K. Varadan, IEEE, PP. 212-215, (2003); “Perspective of Nanotube Sensors and nanotube Actuators,” Toshio Fukuda, Fumihito Arai, Lixin dong, and Yoshiaki Imaizumi, 4^{th} IEEE Conference on nanotechnology, PP. 41-44, (2004); “An Innovative Approach to Gas Sensing Using Carbon nanotubes Thin Films: Sensitivity, Selectivity, and Stability Response Analysis,” C. Cantalini, L. Valentini, I. Armentano, J. M. Kenny, L. Lozzi, S. Santucci, IEEE, PP. 424-427, (2003); “Remote Sensor System using Passive SAW Sensors”, W. Buff et. al. 1994 IEEE Ultrasonics Symposium, PP. 585-588, (1994); and “Chemical Sensors for Portable, Handheld Field Instruments,” Denise Michele, et. al, IEEE Sensors Journal, 1(4), PP. 256-274, (2001). However, none of these references teach or suggest that a microwave resonant cavity has ever been employed or engineered into detection equipment.

### SUMMARY

The present invention relates to a method, sensor, and apparatus for detecting specific materials in a volume of atmosphere. More specifically, the method utilizes nanotubes having specialized functional groups or antigens to bind chemical structures of interest. These structures of interest may be toxic substances, or infectious substances.

One aspect of the current invention is a method detecting a chemical species of interest in a volume of atmosphere. The method comprises: exposing a sensor to a volume of an atmosphere, wherein any chemical species of interest that is contained in the volume of the atmosphere is capable of interacting with the nanotube forming an exposed-sensor, and the sensor comprises a nanotube filter; irradiating the exposed-sensor with microwave radiation under vacuum conditions; and detecting a resonant profile of the exposed-sensor with microwave radiation. In a preferred embodiment, the nanotube filter is selected to be a carbon nanotube (“CNT”) filter that is about 10² μm thick having single walled carbon nanotubes with an average diameter in the range of about 0.5 nm to about 2.5 nm, and preferably about 1.24 nm. Alternatively, the nanotube filter can be buckypaper or bundles of CNT. One method of specifically detecting a chemical species of interest is to add a functional group to the nanotube filter, which allows a first absorption of a first chemical structure to interact with the nanotube filter and be distinguished from a second chemical structure that does not interact with the nanotube filter. The presence of tralomethrin or allethrin are examples of specific chemical species that can be determined using this method.

A second aspect of the current invention is a method detecting an antigen of interest in a volume of atmosphere. This method comprises: dispersing antibodies on a nanotube filter or bundle (bundle as used herein implies more than a single nanotube fiber), forming an antibody dispersed nanotube filter of a few milligrams of materials or more, wherein the antibodies are capable of binding the antigen of interest; exposing the antibody dispersed nanotube filter with a volume of an atmosphere, wherein any antigen of interest that is contained in the volume of the atmosphere is capable of interacting with the antibodies forming an exposed-antibody-nanotube filter; irradiating the exposed-antibody-nanotube filter with microwave radiation under vacuum conditions; and detecting a resonant profile of the exposed antibody-nanotube filter with microwave radiation. In a preferred embodiment, the nanotube filter is selected to be a carbon nanotube (“CNT”) filter that is about 10² μm thick having single walled carbon nanotubes with an average diameter in the range of about 0.5 nm to about 2.5 nm, and preferably about 1.24 nm. Alternatively, the nanotube filter can be buckypaper. One method of specifically detecting an antigen of interest is to add an antibody to the nanotube filter, which allows a first absorption of a first antigen structure to interact with the nanotube filter and be distinguished from a second antigen structure that does not interact with the nanotube filter. The presence of antigen markers that are specific for virulent biologican agent or organism would be examples of interest, including anthrax, bubonic plague, E-coli, botulism, small pox, or other infections agents.

A third aspect of the current invention is a sensor for detecting an agent or antigen of interest in a volume of atmosphere. The preferred sensor comprises: a nanotube filter, wherein the nanotube filter comprises single walled nanotubes arranged as a thin film; and (b) a functional group or antibody coupled to at least one of the single walled nanotubes. In the preferred embodiment of the sensor, the combination of a nanotube filter coupled to the functional group or antibody is capable of absorbing the agent or antigen from a volume of atmosphere, and a spectral analysis of the sensor discerns the presence or absence of the agent or antigen of interest. For example, an antigen of interest may comprise a marker for virulent organism or infections agents, such as anthrax, bubonic plague, E-coli, botulism, small pox, or other viruses that are bound to a carbon nanotube (“CNT”) filter having a thin film about 10² μm thick comprising single walled carbon nanotubes with an average diameter in the range of about 0.5 nm to about 2.5 nm, and preferably about 1.24 nm. Alternatively, the nanotube filter may comprise buckypaper.

A fourth aspect of the current invention in an apparatus for detecting an agent or antigen in a volume of atmosphere. The detection device comprises: a sensor, wherein the sensor comprises a nanotube filter having single walled nanotubes arranged as a thin film; and a functional group or antibody coupled to at least one of the single walled nanotubes, and the functional group or antibody is capable of binding the agent or antigen contained in the volume of atmosphere; a chamber for holding the sensor, wherein the chamber is capable of holding the sensor under a vacuum; a microwave source positioned to emit microwaves toward the sensor in the chamber under a vacuum; and a means for analyzing spectral information of molecules bound to the sensor after the sensor has contacted the volume of atmosphere and following irradiation of the sensor with microwaves. In a preferred embodiment, the chamber comprises a microwave resonant cavity and the microwave source comprises a klystron or microwave emitting diodes.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows the absorption spectrum of buckypaper in the range of 7-12 GHz, and zero represents no absorption and one represents total absorption.

FIG. 2 shows a cavity resonant profile with nanotubes exposed to roach spray for 15 minutes using pure nanotubes, and measured in dBM (decibels).

FIG. 3 shows a block diagram of the basic microwave apparatus used to conduct the pressure studies in connection with the present invention.

FIG. 4 shows a diagram of the tralomethrin molecule.

FIG. 5 shows a diagram of a allethrin molecule.

FIG. 6. Panel 6A shows a microwave resonant cavity used to build the prototype of a toxin sensor. Panel 6B is the prototype of the cavity used for sensing the toxic gases and drugs.

FIG. 7 shows a characteristic curve of a shift in the resonant frequency for trichlorofluoromethane gas with (30 mg) single walled carbon nanotubes (˜2 nm diameter).

FIG. 8 shows a characteristic hysteresis curve showing absorption characteristic of a sample of trichlorofluoromethane gas.

FIG. 9 shows a characteristic hysteresis curve after a polynomial fit describing the strength of absorption of nanotubes for carbon monoxide gas.

FIG. 10 shows absence of hysteresis when no carbon nanotubes were present in the resonant cavity with carbon monoxide flushed for each cycle of pressurizing and depressurizing.

FIG. 11 shows single walled carbon nanotubes loaded in the resonant cavity and were flushed with many different gases. In response it was observed that in the environment where both nanotubes were present the strength of hysteresis was greater as compared to the environment where the nanotubes were absent. This graph is a quantitative measurement of the strength of hysteresis of the system with and without Nanotubes (±) and different gases.

FIG. 12 shows use of the above-mentioned software. An armchair type (10,10) single walled nanotube was created. The white squares depict the possible sites of attaching the dangling bonds of any functionalizing material.

FIG. 13 shows the modeling the nanotubes and their response to any external electromagnetic field. Forcite based calculations are employed to study the dielectric response of the material.

FIG. 14 shows dynamic analysis was done on bundled nanotubes with armchair symmetry and their response to 5 carbon monoxide molecules. Calculations on the enthalpy change (Kcal/Mol) of the system are being performed.

FIG. 15 shows the use of software for an artist's depiction of the possible states of adsorption of the nanotubes for a specific toxin upon their functionalization with certain organic chemicals.

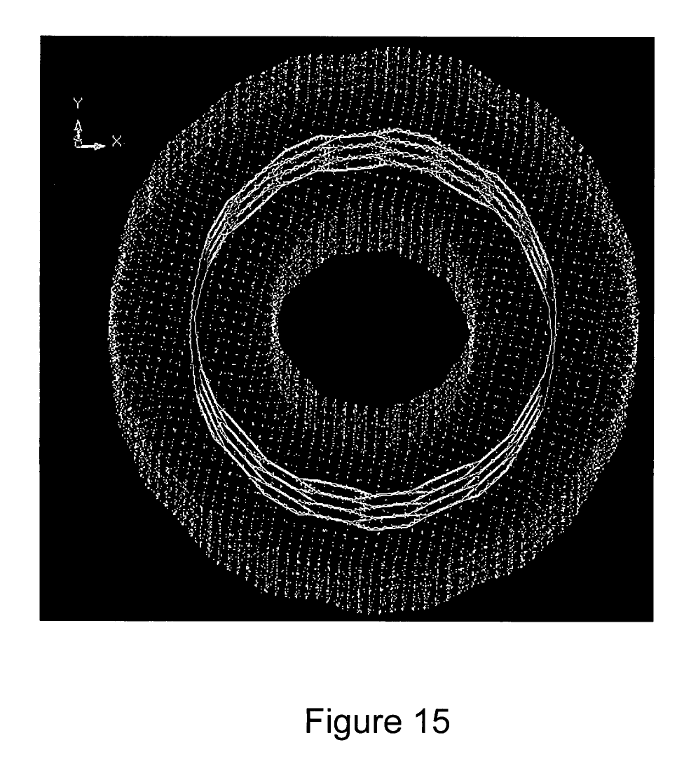

FIG. 16 shows a snapshot of the screen taken from the software that informs us of all the possible calculations that can be performed on a particular ensemble of system. Upon carrying out all the necessary calculations, relevant parameters are stored into the database as shown in FIG. 17, for calibrating the system for a specific toxin.

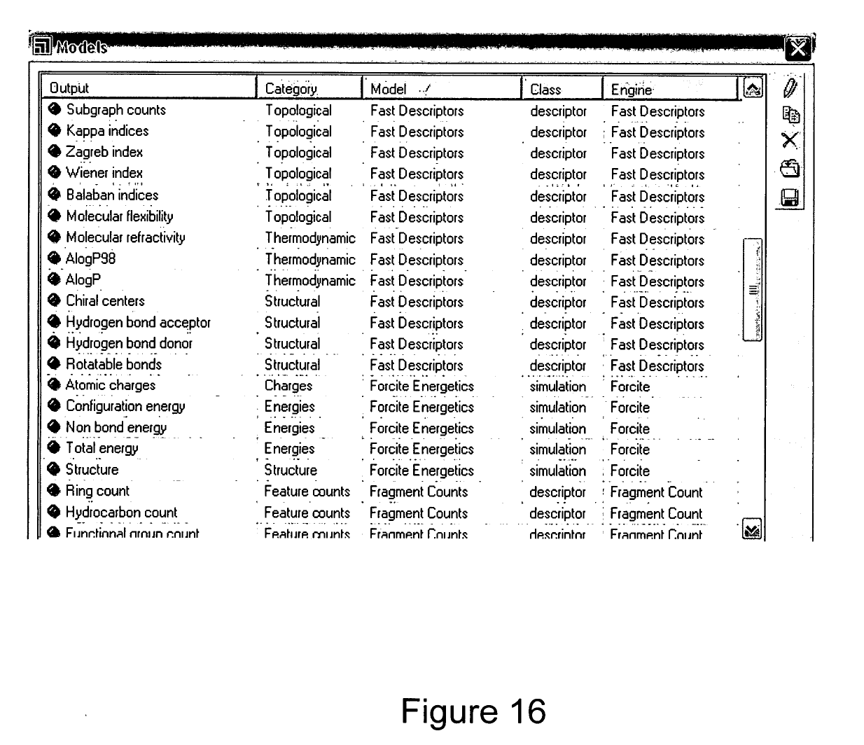

FIG. 17 shows a typical prototype of a structured query language (SQL) based data retrieval system.

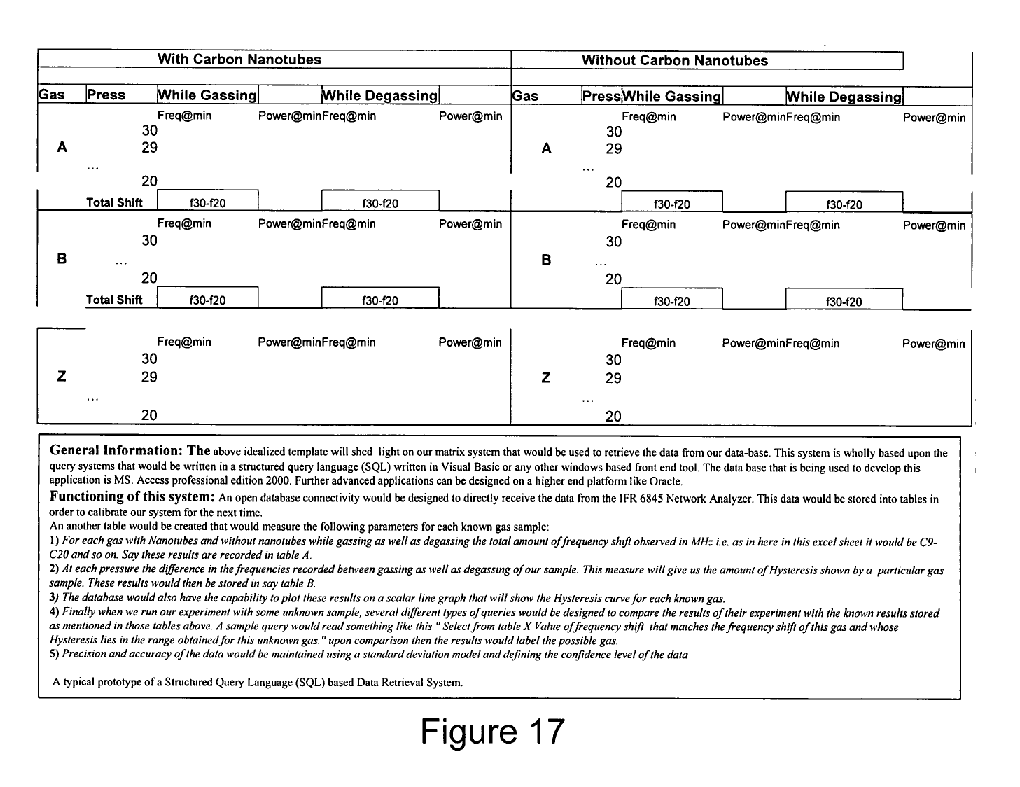

FIG. 18 shows schematics of the electronics that will replace the microwave network analyzer to energize the cavity shown in FIG. 6. The size of these electronics significantly reduces the size of the apparatus and can be compared to the size of a standard cellular phone Siemens Model CF62T.

FIG. 19 shows a simple approach showing how the laboratory research equipment can be engineered into a working portable prototype for the detection equipment.

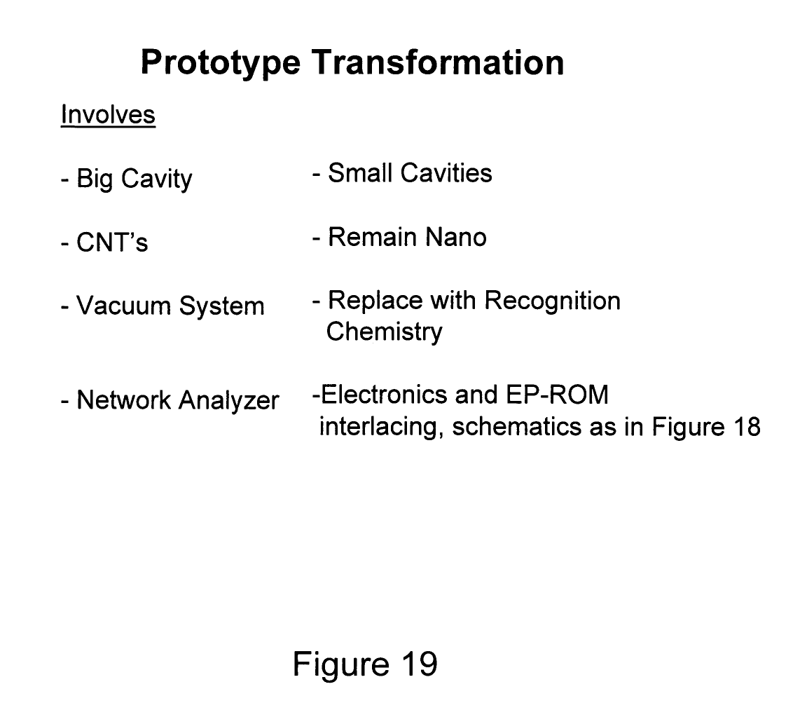

FIG. 20 shows a table of sensor technologies.

### DETAILED DESCRIPTION OF THE PRESENT INVENTION

The present invention is related to a method, apparatus, and system for sensing and detecting various biological and chemical agents. More specifically, the present invention utilizes nanotube structures in a particle detection process. As described herein, antibodies for agents such as anthrax, bubonic plague, e-coli, botulism, small pox and fast spreading viruses such as SARS are homogeneously dispersed on a nanotube filter such as a CNT filter, including buckypaper. Agents as used herein generally means infections or virulent agents, including viruses, organisms, bacteria's, fungus, molds, parasites, and genes, nucleic acids or proteins. The filter is then placed into a device which facilitates filtering volumes of the atmosphere or food material. Any pathogen or toxin corresponding to the specific antibody held by the filter would react with the antibody and be retained on the filter. The filter would then be subjected to microwave treatment and spectral analysis as described herein. The present invention has advantages over conventional methods, apparatus and systems, including speed, simplicity, sensitivity, and specificity of testing. An exemplary embodiment of the detector method, apparatus and system described herein is for use in testing the air for biological agents, including pathogens and toxins, and for the testing of food for pathogens and toxins. The method, apparatus and system of the present invention would be particularly well adapted for use by the military in battle zones and to civilian agencies in homeland security.

One method of producing buckypaper utilizes about four hundred milligrams SWNT from a high-pressure CO process that are added to a 250 ml round bottomed flask equipped with a condenser and magnetic stirrer. Fuming sulfuric acid (about 125 ml, 27-33% free SO₃) was added to the flask and stirred. After mixing is complete, the paste was thick and difficult to stir at room temperature. The paste was subsequently heated to 90° C. and stirred for about 48 hours. The cooled contents of the flask were added drop wise to ether (500 ml) cooled in an ice bath with vigorous stirring. This was allowed to sit for 15 minutes and then filtered through a PTFE (0.5 micron) filter paper. The SWNTs where again suspended in acetonitrile/ether (50:50, 250 ml), sonicated for 15 min and recovered by filtration. The fuming sulfiric acid processed SWNT material forms a defined filtrate paper, which is quite robust. Other acids that are known to intercalate graphite will also facilitate the formation of super-ropes.

In the present invention, antibodies for agents such as anthrax, bubonic plague, e-coli, botulism, small pox and fast spreading viruses such as SARS are homogeneously dispersed on a nanotube filter, such as a carbon nanotube filter, including buckypaper. The filter is then placed into a device that facilitates filtering volumes of the atmosphere or food material. Any pathogen or toxin corresponding to their specific antibody held by the CNT filter (“nanofilter”) would react with the antibody and be retained on the filter. The nanofilter would then be subjected to microwave treatment and spectral analysis as described herein. One of ordinary skill in the are understands that isolated antibodies can be produced for nearly any type of isolatable antigen, and the technology to produced different antibodies well defined in the art (e.g. Antibodies : Volume 1: Production and Purification by G. Subramanian (Editor); ISBN: 0306482452, which is incorporated herein for reference for all purposes), and the used of different antibodies other than the exemplary ones mentioned here are within the spirit and scope of the invention.

Biomolecules described can be immobilized on the nanotubes of the using techniques that are already known in the art, for example, using an immobilization agent such as 1-pyrenebutanoic acid, succinimidyl ester. Although not wanting to be bound by theory, using 1-pyrenebutanoic acid, succinimidyl ester, the pyrenyl group, being highly aromatic in nature, interacts strongly with the sidewalls of nanotubes via pi-stacking. A succinimidyl ester group is used to covalently conjugate the desired biomolecules, e.g., proteins, antibodies or ligands containing amine groups through the formation of amide bonds. See Chen, R., et al., J. Am. Chem. Soc. 123, 3838 (2001), which is incorporated herein for reference for all purposes.

### EXAMPLES

The following examples are provided to further illustrate this invention and the manner in which it may be carried out. It will be understood, however, that the specific details given in the examples have been chosen for purposes of illustration only and not be construed as limiting the invention.

### Example 1

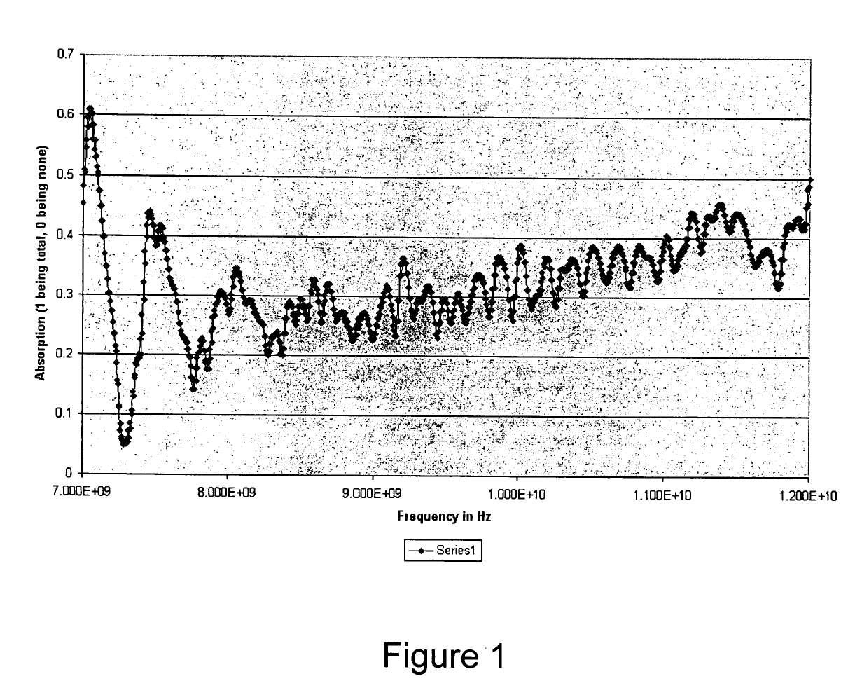

Microwave Interactions with Nanostructured Materials. In order to show the interaction of microwave radiation with CNTs, microwave absorption spectra measurements were collected. In these measurements, a thin film of SWNTs was synthesized from samples of nanotubes obtained from Carbon Nanotechnologies Incorporated (“CNI”) of Houston Tex. The samples available from CNI are synthesized from a high pressure CO disproportionation (“HiPco”) process. The nanotubes obtained from CNI show by Raman spectroscopy and transmission electron microscopy (“TEM”) to have average diameters of 1.24 nm. The thin film of this material was on the order of 10² μm thick. Analysis was done with absorption spectra acquired at standard temperature and pressure as well as under a variety of vacuum conditions and across a range of microwave frequencies as can be seen in FIG. 1.

The sample was placed in a microwave waveguide in such a way as to block the waveguide. One embodiment of the present invention includes an arrangement of a thin film of SWNTs having dispersed thereon antibodies, such thin film of SWNTs being placed in a microwave waveguide. A microwave generator is adapted to emit microwaves toward the thin film of SWNTs. The amount of microwave power reflected from the thin film of SWNTs as well as transmitted through the thin film was monitored with waveguide to coax converters and fed back into a network analyzer. The absorption level A was calculated by subtracting the total transmitted power and the total reflected power from the input power, and the dividing by the original input power.

The observed absorption levels seen in various samples of SWNTs are abnormally high, but can be understood based on the typical mechanisms for microwave absorption. In general, dielectric and semiconductor substances are excited via permanent dipole moments, induced dipole moments, quadrupole moments, and other transition dipole mechanisms involving electronic resonances. Conductive materials, such as metals, which lack these types of mechanisms, would be expected to be very good conductors at these wavelengths (ideal Drude tail) and thus should not either lose or absorb radiation. However, other mechanisms are known to exist that involve a type of resistive heating. In the case of nanotubes, all of these mechanisms can be present in any sample, leading to unique possibilities for microwave interactions. The unique characteristics of CNTs provide very strong resonant effects, which may be employed for applications should their fundamental properties be fully understood.

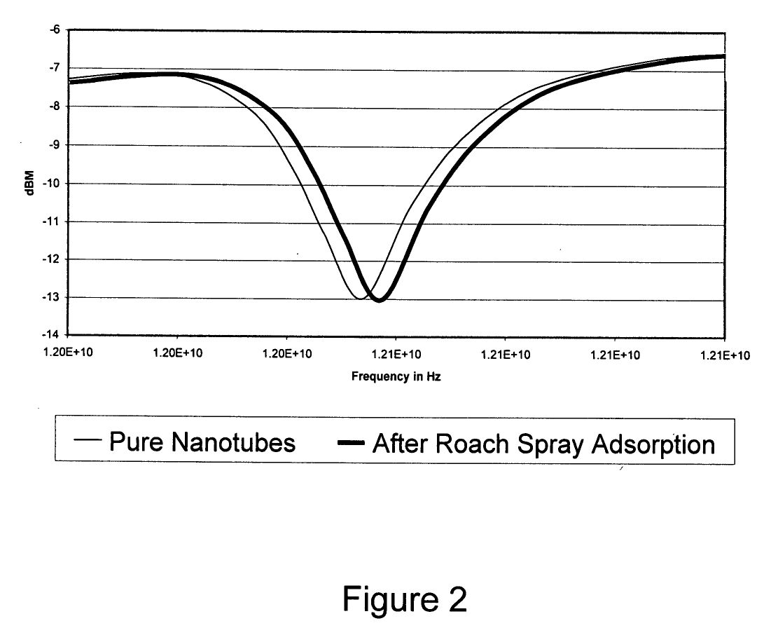

In order to examine the use of these interactions as a detection method for toxins, a 2.5 mg sample was placed in a resonant cavity in vacuum conditions (10⁻⁹ torr). Then 10 parts per billion of Black Flag brand roach spray (a toxin for insects) was introduced to the cavity. As seen in FIG. 2, after approximately 5 minutes, the frequency of the cavity shifted which indicated a change in the resonant frequency of the nanotubes sample as the spray was in the environment for that amount of time with no observed shift until adsorption had an opportunity to occur. The time until shift may be accelerated by the addition of proper functional groups to aid in the attachment. As an additional check, alcohol was introduced to the cavity at the same level with no shift seen after approximately 45 minutes. To ensure stability and accuracy of measurements, 50 sweeps of the cavity were taken with no shifts in resonant conditions detected.

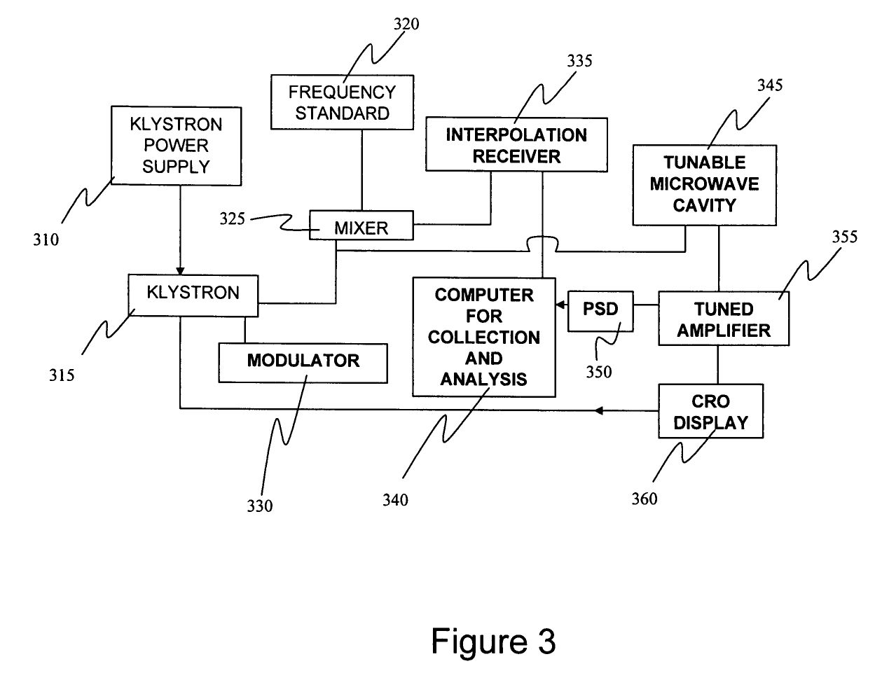

Microwave apparatus used to conduct the pressure studies. A block diagram of the basic microwave apparatus that is useful to conduct the pressure studies is shown in FIG. 3. A Klystron power supply (310) is in electrical communication with a Klystron (315). The Klystron is in communication with a modulator (325); a modulator (330); and a turnable microwave cavity (345). The Mixer (325) is in communication with a frequency standard (320) and an interpolation receiver (335), which connects to a computer for collection and analysis (340). The trunable microwave cavity (345) is in communication with a tuned amplifier (355), which is connected to a PSD (350) that is also communicating with the computer for collection and analysis (340). The tuned amplifier (355) is in communication with the CRO display (360), which is in communication with the Klystron (315).

Functionalization. In order to allow more efficient absorption of the species for which the sensor is designed to detect, functionalization of nanotubes will improve the selectivity and controllability of the sensor. In order to make the most efficient use of this nanotube based device, chemical modification of the nanotubes can be conducted. This functionalization allows greater control and removal of ‘false alarms’ of sensor output. Many methods are available to functionalize CNTs. Controlled functionalization allows the tailoring of the structural and electronic properties of the CNTs.

It has been shown that chemical reactions involving fullerenes is a type of additive reaction. There is an enormous amount of strain energy present in these molecules. There have been many reports of functionalization in the scientific literature, the end result being a sample of nanotubes that is chemically bonded to the CNTs in the sample in some organized fashion. These functional groups take on many molecular forms which are useful for control in the present invention.

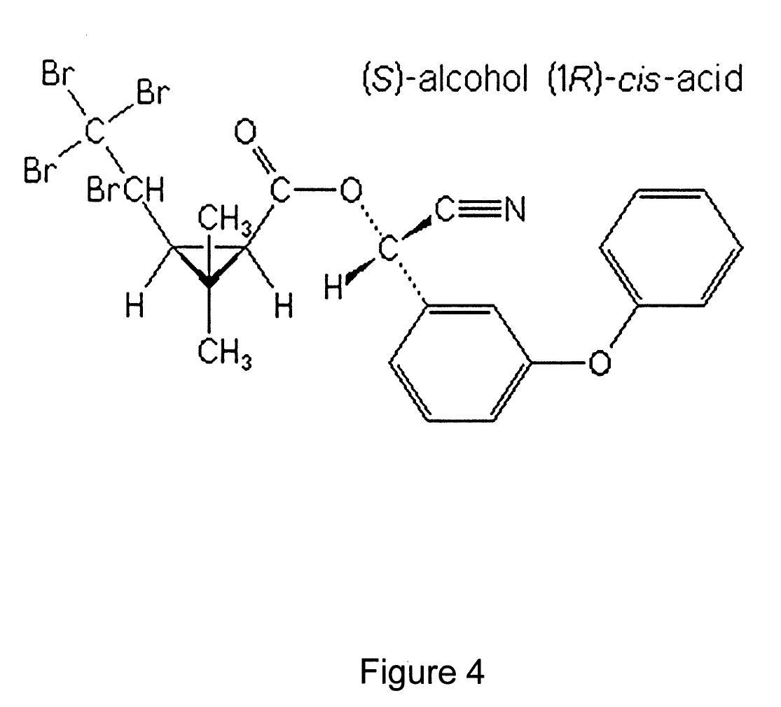

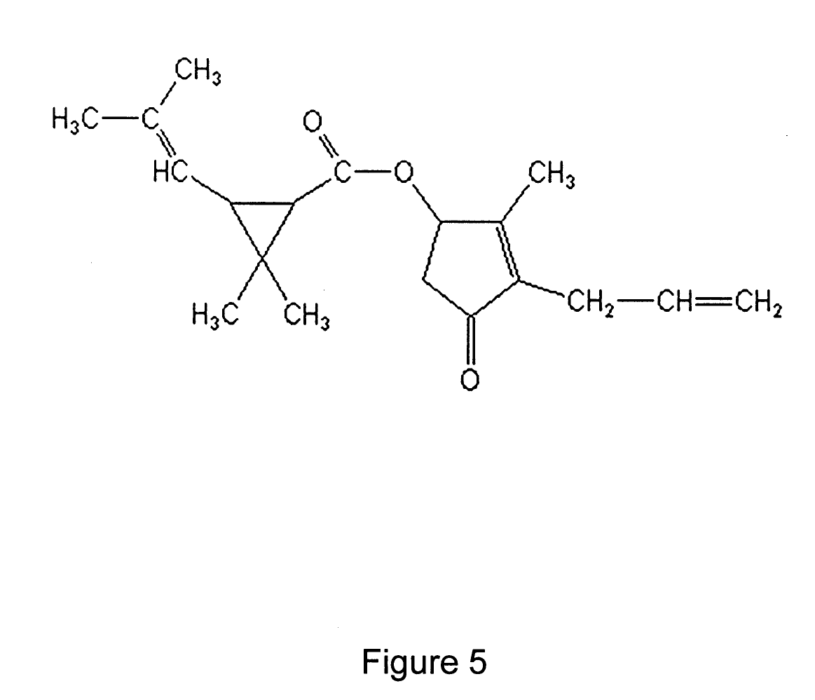

Two active ingredients in roach spray are Tralomethrin (C₂₂H₁₉Br₄NO₃), as seen in FIG. 4, and Allethrin (Cl₉H₂₆O₃), as seen in FIG. 5. These molecules are essentially nerve agents for roaches. These molecules are weak, having limited effects to humans, the conventional military versions being much stronger, thus allowing easier detection. Nonetheless, the weak versions were detected at approximately 1 part per billion adsorbed to the nanotube matrix.

Since the discovery of CNTs, various materials other than carbon have been found to form nanotube materials, including, but not limited to the boron nitride nanotube. In the case of the present invention carbon tends to be the most useful material for use therein, although the present invention may be implemented using other nanotube materials.

### Example 2

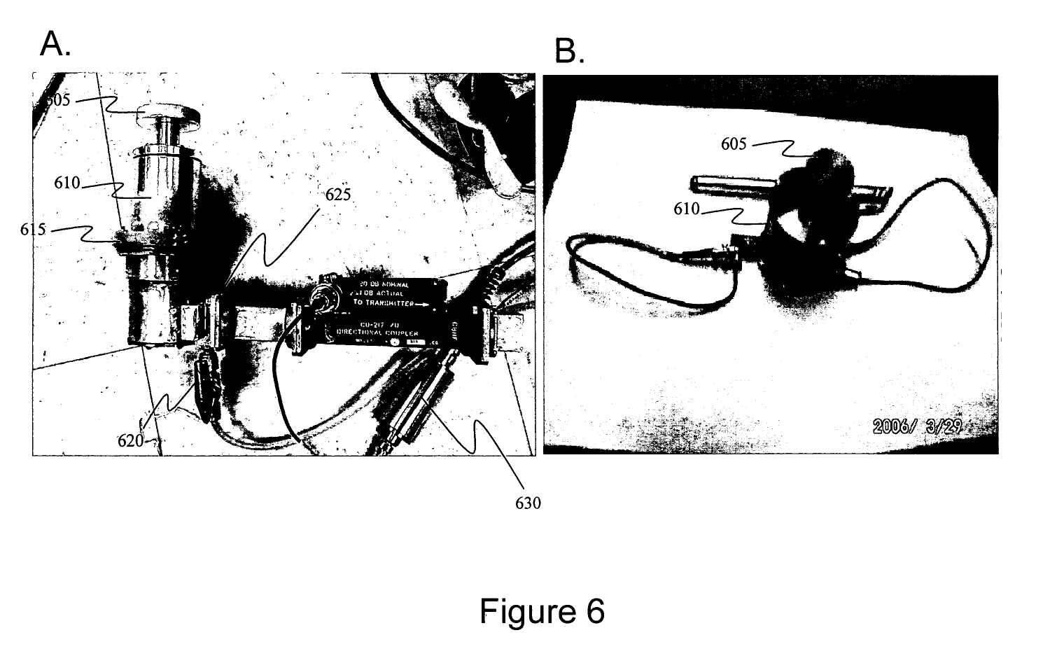

One embodiment of this invention utilized a resonant cavity, as shown in FIG. 6. The general difference between FIGS. 6A and 6B, is the dimensions of the cavities. Otherwise, the theory and the functionalities for both these cavities shown are similar, as will be described below. The cavity shown in FIG. 6A was utilized to characterize the interaction between the gases and the microwaves. The Quality factor was found to be of the order of about 5000. The design of this cavity, although functional, can be cumbersome in regards to opening and sealing the chamber after loading the samples. In this regard, many different designs can be employed without deviating from the spirit and scope of the invention. For example, the resonant cavity shown on the in FIG. 6B is a portable version of the large cavity. In this example, a slight difference in the Quality factor of the cavity was recorded to be slightly lesser value about 4000. The design of the resonant cavity of FIG. 6B is generally more simple with regards to opening and sealing with the load placed inside this cavity. However, both cavities shown in FIG. 6 built using copper material and have the same general operation. The interior of these cavities or the walls of the cavities have been silver polished to reduce the ohmic losses of the signal. As shown in FIG. 6A (605) comprises a tuning cap having an attached movable piston rod that extends to the bottom half of the cavity. This rod on its bottom half has a circular plate attached to it whose diameter is about 1 mm less than the inner diameter of the cavity. Moving the piston either up or down allows a user to change the effective volume of the cylinder or the cavity and, hence, the resonant mode of the cavity. Basically the preferred operation is to resonate the cavity in the most fundamental mode for maximum sensitivity. This can be achieved by the tuning piston and its position inside the cavity. An exploded view of this section is shown in FIG. 6C. One example of the Basic Cylinder (610) making a cavity, is comprised of two halves. The upper half houses the shaft assembly and the bottom half is where the sample is placed. The two halves are connected to each other through screws and a rubber o-ring, to hold the vacuum inside the cavity. The joint where the two halves are joined (615) are fastened together with screws and a rubber o-ring. One of ordinary skill in the art will recognize that other designs and means (e.g. threaded joint, bolts, clams, etc.) for fastening the sections together could be utilized without departing from the spirit and scope of the invention. An inlet hole (620) in the waveguide assembly of the cavity that allows the flow of the gas through the cavity. This hole acts as either an entry or an exit point for the foreign agent (e.g. vapors, gas, dust) into the cavity through any type of tubing depending upon the chemical nature of the gas being used for testing. This tubing is eventually hooked to a vacuum pump or other means for evacuating the chamber. A waveguide-coupling joint fitted with Teflon based patch (625) allows propagation of the microwaves from the source to this target is attached to a vacuum tight cavity. Although not wanting to be bound by theory, the Teflon allows transmission of the electromagnetic radiation with a minimum loss in the strength of the signal serves a dual purpose; transmission as well as holding the vacuum in this extended region of the cavity. The entrance of the cavity comprises an iris hole which allows the entry of the microwave signal inside the cavity either as an intense electric field or an intense magnetic field, depending upon the geometry of the cavity and the mode it is operating in. The size of the hole also depends upon the wavelength of the electromagnetic radiations and their resonant frequencies. A Detector (620) that comes with a typical microwave network analyzer was used in this experiment to detect the microwaves in the cavity. The Detector (620) comprises a detector that converts the analog signal into a digital form and will be. responsible for detecting the shift in the reflected or transmitted signal from the cavity. A pair of co-axial cables this detector is attached to the receiving end of the waveguide. FIG. 6B shows an alternative one piece microwave resonant cavity cylinder chamber (611). In this embodiment, the only detachable region is the top of the cavity, which is attached to the main cylinder through the screws as shown (617).

A resonant cavity, as shown in FIG. 6 operating in TM₀₁₀ mode, is used to sense the absorption response of single walled carbon nanotubes (SWNTs) and other nanomaterials for different types of gas molecules. The range of the frequency signal as a probe for sensing was chosen arbitrarily between 9.1-9.8 GHz. Other highly specific ranges of frequencies can be used to tune the circuitry to sniff particular types of toxins, depending upon their concentration and polarity. It was found that for varying pressures of different gases and different types of nanomaterials, there was a different response in the shifts of the probe signal for each cycle of gassing and degassing of the cavity. The preliminary work done, suggests that microwave spectroscopy of the complex medium of gases and SWNTs can be used as a highly selective and sensitive technique for studying the complex dielectric response of different gases when subjected to intense electromagnetic fields within the cavity.

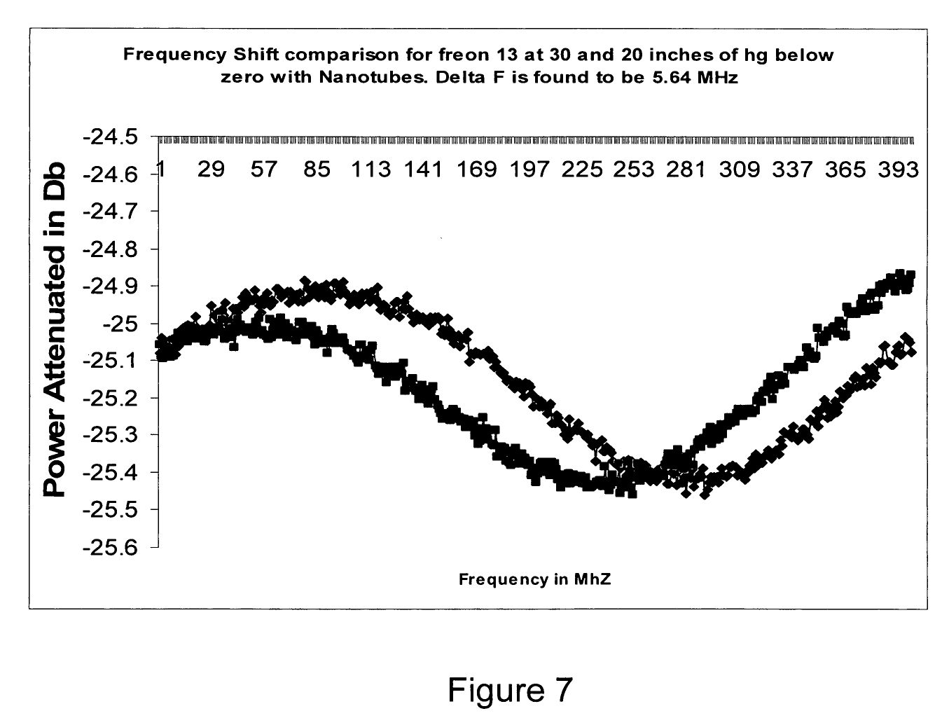

SWNTs have been shown to exhibit a number of unusual properties in their electrical conductivity and in their complex dielectric response. Due to their unusual properties, they have been employed in numerous applications. Since their discovery, researchers worldwide have shown interests in these materials. Studies are being done on these materials to characterize their electrical, optical, mechanical, as well as, their thermal properties. This invention utilizes the absorption response of these SWNTs when loaded in a microwave resonant cavity and perturbed with a loading gas. Resonant cavities are well-known, highly sensitive devices that have been used to make measurements of fundamental properties of matter in all its phases. A resonant cavity can be considered to be multiple LCR circuits connected in parallel. These resonant cavities have widely been studied in determining the shifts in the resonant profiles because of their high quality factor (around 5000). The Frequency range of 9.1-9.8 GHz was used in one experiment to scan the cavity with the load placed in the most intense electric field vector of the cavity. Upon perturbing the cavity with a small load (30 mg SWNTs) there was a shift in the center frequency of the apparatus, as shown in FIG. 7. Also in this figure, it can be seen that a broadening of the width at half power maxima of the typical Lorentzian line shape occurs. Using fundamental properties of shift in the resonance, broadening of the spectral lines and change in the amplitudes of the peaks as indicators, thus, resonant cavities were found to be excellent detectors for a given gas. From these initial observations, it followed that the resonant cavities of miniature size could be engineered. The addition of functionalized SWNTs or other nanoporous materials, specific for a given species to be adsorbed, could be selectively and sensitively detected. The functional group in this case is attached to dangling bonds created by subjecting the SWNTs to intense electromagnetic radiation in order to damage the tubes. This functional group is added in an exchange type reaction, such as by fluorination. In this case, the fluorine group is then exchanged with an active group of the toxin species and does so with a high degree of specificity. This method of actively sensing the foreign toxins proves to be unique. Similarly, an antibody for a specific antigen (such as would occur in a biological toxin) could be added as a functional group. Upon reaction of the antibody and antigen moieties, frequency shifts may be observed upon exposure to microwaves irradiation in the cavity.

Resonant cavities loaded with the carbon nanotubes and other porous materials have shown affinity for select gases. Tests were made with both pure and functionalized carbon nanotubes to develop maximum sensitivity and selectivity for the device. A battery of test data for select gases was used to developed an inventory of potential gases that can be sensed with the apparatus. A typical shift in the resonance frequency with an increase or decrease of the gas pressure into the cavity is shown in FIG. 7. These measured shifts are different for different gases and are also different for different gases when tested with different porous materials.

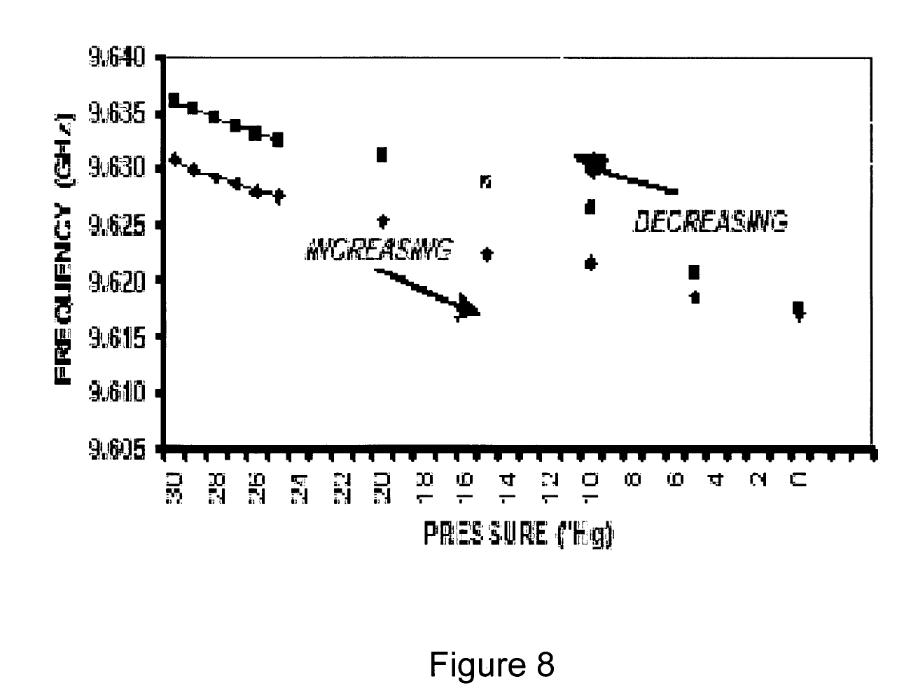

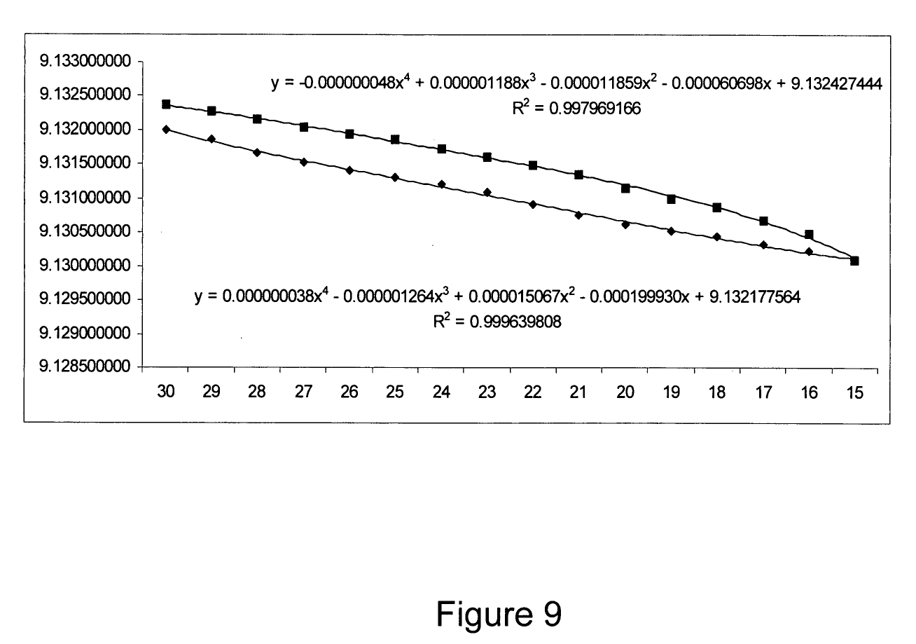

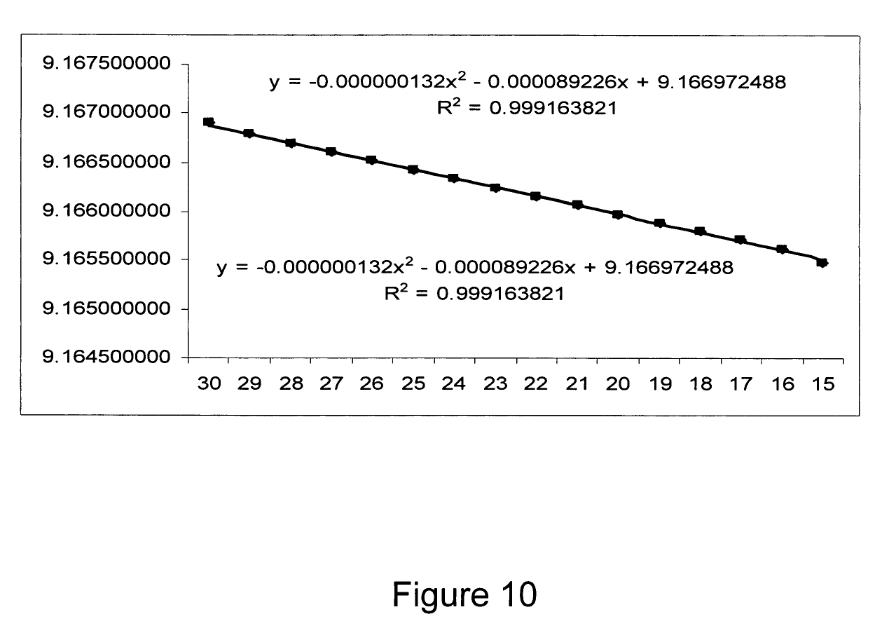

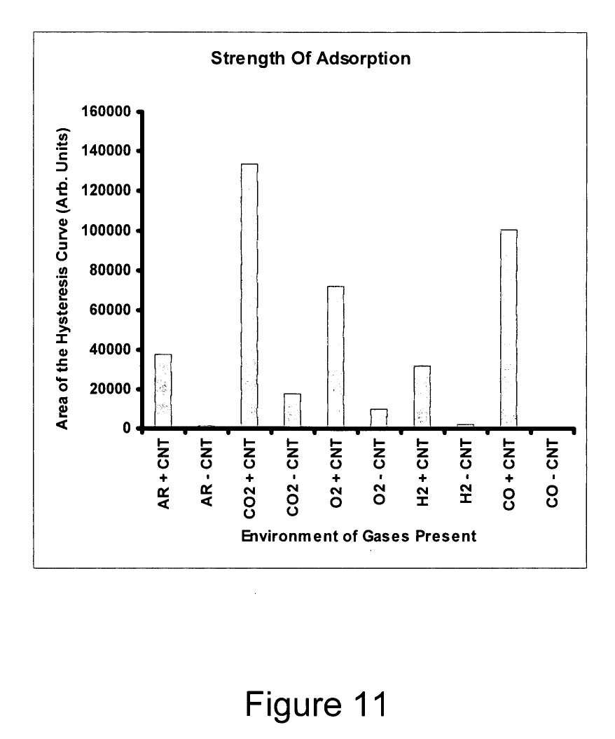

Hysteresis curve as seen in the FIG. 8 was obtained by running a cycle of pressurizing and depressurizing of the cavity with gases. The area under the curve as estimated by the polynomial fit in the FIG. 9 and FIG. 10 is a direct indication of the strength of absorption/desorption of the sample loaded in the cavity. The absence or negligible area under the curve as in FIG. 10 when no nanomaterials were present indicates the affinity of nanomaterials for various gases. FIG. 11 summarizes a battery of tests done for one particular type of SWNT after being impregnated with different types of gases.

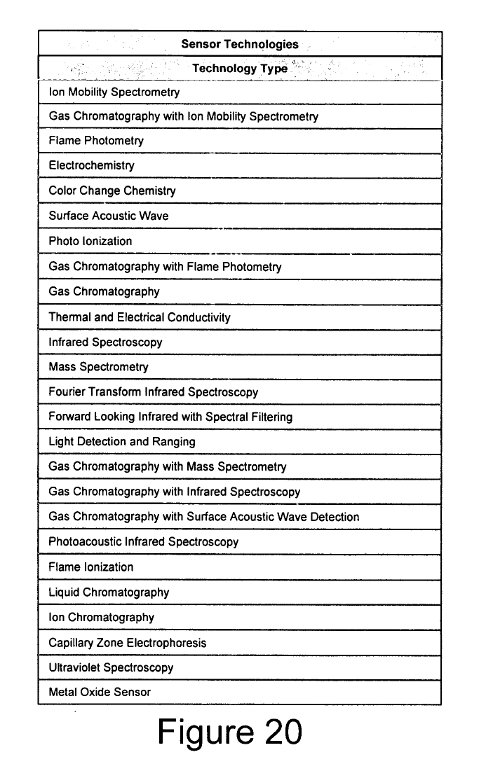

The absence of any such observations as seen in FIG. 10 indicates the working model of the detection problem. Highly sensitive techniques of determining the loss tangents and frequency shifts in the signature profiles for specific gases. Also this method would not only be sensitive but even accurate in determining the real and the imaginary parts of the dielectric constants of the composite environment. An increase in the specificity as well as an effective decrease in the response time has been observed in this method compared to the other methods. From the report obtained from the Department of Defense Technical Information Center, as shown in FIG. 20 is summarized the broad areas of technologies that have been used for the manufacturing of Chemical Agent and Toxic Industrial Material Detection Equipment.

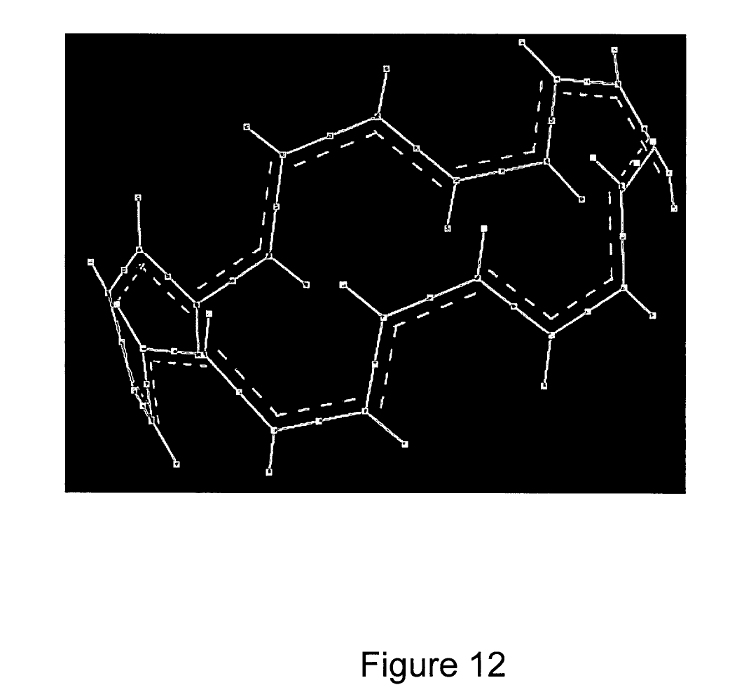

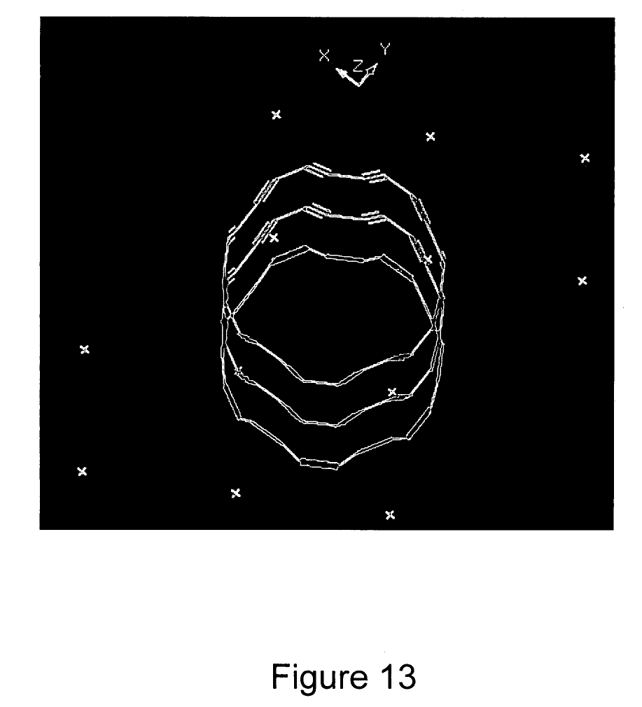

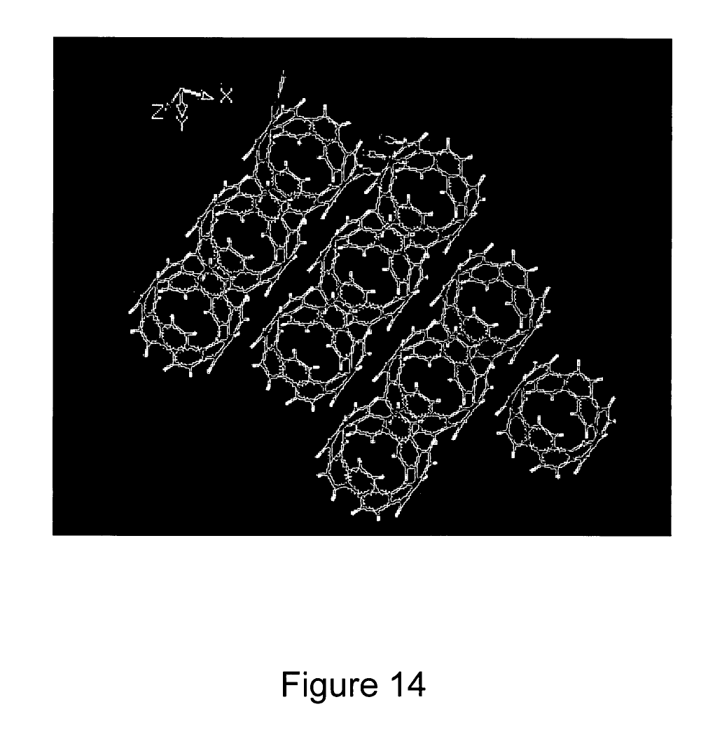

Theoretical Modeling and Molecular Dynamics. Material Studio 4.0 from Accelrys Systems was used to theoretically model the nanostructures and understand the molecular and kinetic dynamics of absorption and Fictionalization of Nanotubes and other crystal structures, as shown in FIGS. 12-14. For Example, FIG. 12 shows the use of the above-mentioned software an armchair type (10,10) single walled nanotube that was created. The white squares depict the possible sites of attaching the dangling bonds of any functionalizing material. FIG. 13 shows the modeling the nanotubes and their response to any external electromagnetic field. Forcite based calculations are employed to study the dielectric response of the material. Figure shows dynamic analysis that was done on bundled nanotubes with armchair symmetry and their response to 5 carbon monoxide molecules. Calculations on the enthalpy change (Kcal/Mol) of the system were performed.

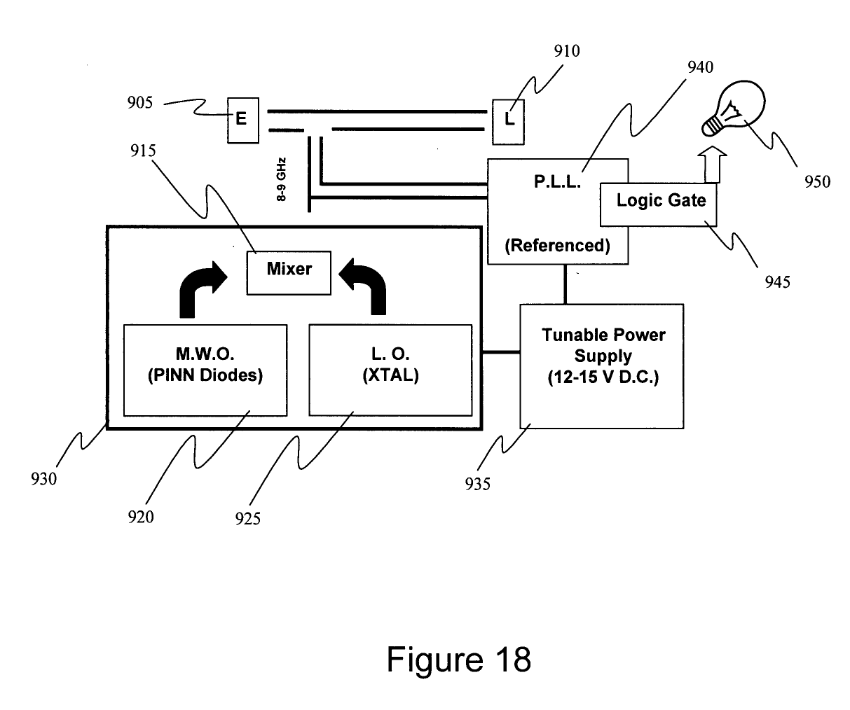

One advantage of this system stems from a very high quality factor (Q), operational frequency in the domain of Gigahertz range as well as with the use of chemically functionalized nanoporous materials the device holds an intrinsic merit compared to the others in terms of sensitivity and selectivity. As shown in FIG. 6 and FIG. 18 the end product would be a compact device with very high sensitivity, specificity for detection of nanotubes selectivity can be improved by expansion of a database, as well as, functionalization of nanotubes. Functionalization and tailoring of the nanotubes for a specific toxin indeed will result in fewer false alarms. As the basic components of the circuitry energizing the cavities consist of low powered microwave diodes, and due to the significant decrease in the ohmic losses within the polished walls of the cavity this device will have a longer lifetime of operation. Microwave electronics have so far widely been used in communications for both military as well as civilian purposes, this device is capable of remote sensing, thereby, minimizing the human involvement in detection. Also due to advancement in the semiconductor industry, the prices of the components involved in the circuitry are negligible. Hence, the cost of operation of this device will be significantly less compared to the other technologies mentioned above.

Nanoscale samples with different porosity and dielectric properties, radio frequency source generators, network analyzer for signature analysis, computer database model one shown in FIG. 11. The data obtained from each run is used to retrieve the information for any specific query. As shown in FIG. 18, microwave resonant oscillators (“MRO”) made from PINN diodes (920), a mixer (915), a crystal local oscillator (925) (“CLO”), a phase locking loop (940) (“P.L.L.”), variable resistors, a 12 to 15 volts D.C. battery, LCD screen, cavities drilled out of copper tubings, and TTL type logic circuits (945) are also employed in the invention. More specifically, FIG. 18 is an schematic embodiment of the electronics used for this type of detection technology. An empty cavity with no load of nanomaterials inside is represented in (905), and (910) comprises a loaded cavity with specifically functionalized nanotubes ready to sniff a specific toxin. The two cavities are coupled together through a waveguide in between to formed a “see-saw” like plane. A signal mixer (915) that can mix the input from a local oscillator and a microwave oscillator with f1±f2 frequency with respect to the beat frequency. One of ordinary skill in the art is capable of designing alternative models without diverging from the sprit and scope of this basic design. Microwave Oscillators (920) can be PINN diodes which have capability of generating high frequency microwaves by letting in a small D.C. potential. A Local Oscillator (920) is capable of providing the beat note as a reference. The housing (930) is used to carry the electronics. A 12-15 Volts Battery (935) is utilized for powering the portable unit, and can be nickel or lithium based batteries, but other power sources known in the art can be utilized that do not diverge from the spirit or scope of the invention. The Phase locking loop (940) is capable of locking the output of the dual cavities with the incoming reference signal. Any change in the response of the cavities will cause the potential shift in the circuitry. Although not wanting to be bound by theory, the role of the phase locking loop is to adjust the potential of the system back to original by feeding more power from the battery into the circuitry. The logic gates (945) are capable of measuring and comparing the stored information in its memory of a standard database for different chemicals having different potential shifts, wherein the output of the logic gate will be either on or off. The on or off state of the logic gate device will then indicated to the user to status the environment that is being monitored. For example, an alarm system (950) shows a light bulb as a visual alarm, however, it will be appreciated that one of ordinary skill in the art that other types of alarm systems can be utilized, (e.g. visual, acoustic, or a signal transmitted to a remote location), such deviations are not considered to be outside the spirit and scope of this invention.

### REFERENCES CITED

The following references, to the extent that they provide exemplary procedural or other details supplementary to those set forth herein, are specifically incorporated herein by reference.

### U.S. PATENT DOCUMENTS

United States Patent Application 20050169830, filed in the name of Richard, Smalley E., et al., and published on Aug. 4, 2005 titled: “Macroscopic Ordered Assembly of Carbon Nanotubes,”

United States Patent Application 2004/0200734 filed in the name of Man Sung, et al., and published on Oct. 14, 2004, titled “Nanotube-based Sensors for Biomolecules,”

### REFERENCES

Bethune, D. S., et al., Nature, 363, 605-607, (1993).
Chen, R., et al., J. Am. Chem. Soc. 123, 3838 (2001).
Chiang, I. W., B. E. Brinson, A. Y. Huang, P. A. Willis, M. J. Bronikowski, J. L. Margrave, R. E. Smalley, and R. G. Hauge, J. Phys. Chem. B 2001, 105, 8297-8301.
Dresselhaus, M. S., A. Jorio, A. G. Souza Filho, G. Dresselhaus, and R. Saito, “Raman spectroscopy on one isolated carbon nanotubes,” Physica B, (2002) 15-20.
Haddon, R. C., Science, 261, 1545-1550 (1993).
Hamada, N., S. Sawada, and A. Oshiyama, “New one-dimensional conductors: graphitic microtubules,” Phys. Rev. Lett., 68, (1992) 1579.
Iijima, S., “Helical microtubules of graphitic carbon,” Nature, 354, 56-58 (1991).
Iijima, S., and Toshinari Ichihashi, Nature, 363, 603-605 (1993).
Kroto, H. W., et al., Nature, 318, 162-163, (1985).
Nikolaev, P., M. J. Bronikowski, R. K. Bradley, F. Rohmund, D. T. Colbert, K. A. Smith, and R. E. Smalley, “Gas-phase Catalytic Growth of Single-Walled Carbon Nanotubes from Carbon Monoxide,” Chemical Physics Letters, 313, 91 (1999)
Nhut, J. M., R. Vieira, L. Pesant, J. P. tessonnier, N. Kellar, G. Ehret, C. Pham-Huu, and M. J. Ledoux, “Synthesis and catalytic uses of carbon and silicon carbide nanostructures,” Catalysis Today, 76, 1, 11-32.
Ong, K. G., K. Zeng, and C. A. Grimes, IEEE Sensors Journal, Vol. 2 No. 2, April 2002.
Saito, R., M. Fujita, G. Dresselhaus, and M. S. Dresselhaus, “Electronic structure of graphene tubules based on C₆₀,” Phys. Rev. B, 46, (1992) 1804.
Salvetat, J. P., J. M. Bond, N. H. Thomson, A. J. Kulik, L. Forro, W. Benoit, L. Zuppiroli, Appl. Phys. A., 69(3), 1999, 255-260.
Strong, K. L., D. P. Anerson, K. Lafdi, J. N. Kuhn, Carbon, 41 (2003) 1477-1488.
Townes, C. H., A. L. Schawlow, Microwave Spectroscopy, Dover Publishing, New York, N.Y., 10014, 1975.
Congressional Testimony, “Threat of Terrorism to the United States,” <http://www.fbi.gov/congress/congress01/freeh051001.htm>, (May 2001) Accessed date: January 2006.
A military Guide to Terrorism in the Twenty-First Century”, <http://www.fas.org/irp/threat/terrorism/index.html,>(Aug. 15 2005) Accessed Date: January 2006.
Roberts, J. A. et. al, “Electromagnetic wave properties of polymer blends of single wall carbon Nanotubes using a resonant microwave cavity as a probe, Journal of App. Phys. 95, 8, 4352, (2004)
Hong, K. H., “Microwave Properties of Liquids and Solids Using a Resonant Microwave Cavity as a Probe”, PhD dissertation, University of North Texas (1974). “Microwave Properties of Liquids and Solids Using a Microwave Cavity as a Probe” (with K. H. Hong) J. Appl. Phys. 45, 2452-2456 (1974).
Slater, J. C., Rev. Mod. Phys. 18, 441 (1946)
Van Bladel, J., “Electromagnetic Fields,” Mc-Graw Hill Company, Chapter 10 (1964)
Townes, C. H. & A. L. Schalow, “Microwave Spectroscopy,” Dover Publications, Chapter 14, PP. 378, (1975)
“Guide for the Selection of Chemical Agent and Toxic Industrial Material Detection Equipment for Emergency first Responders,” U.S Department of Justice and Department of Defense Technical Information Center Report. (2000)
“A Novel Acoustic Gas and Temperature Sensor,” Jason D. Sternhagen et. Al., IEEE Sensors Journal, 2(4), (2002)
“Modeling of Double Saw Resonator Remote Sensor,” M. Binhack et. al., IEEE 1416-2003 Ultrasonic Symposium, (2003)
“The RF-Powered Surface Wave Sensor Oscillator- A Successful Alternative to Passive Wireless Sensing,” Ivan D. Avramov, IEEE Transactions on Ultrasonic, Ferroelectrics, And Frequency Control, 51 (9), (2004)
Optimization of Gas-Sensitive Polymer Arrays Using Combinations of Heterogeneous and Homogeneous Subarrays,” D. M. Wilson, IEEE Sensors Journal, 2(3), (2002)
“Effects of Electrode Configuration on Polymer Carbon-Black Composite Chemical Vapor Sensor Performance,” Brian matthews et. al. IEEE Sensors Journal 2(3), PP. 160. (2002)
“Gas Sensitivity comparison of Polymer Coated SAW and STW Resonators Operating at the Same Acoustic Wave Length,” Ivan D. Avramov et. al, IEEE Sensors Journal, 2(3) PP. 150, (2002)
“Carbon Nanotube—based resonant circuit sensor for ammonia,” S. Chopra et. al, Applied Physics letters, 80(24), (2002)
“Gas Molecule adsorption in carbon nanotubes and nanotube bundles,” Jijun zhao, Alper Buldum, Jie Han, Jian Ping Lu, Nanotechnology, 13, PP. 195-200, (2002)
“Nanosignal Processing: Stochastic Resonance in Carbon Nanotubes That Detect Subthreshold Signals,” Ian Y. Lee, Xiaolei Liu, Bart Bosko, Chongwu Zhou, NanoLetters, 3(12), PP. 1683-1686 (2003)
“Three Dimensional polymer MEMS with functionalized Carbon Nanotubes and modified organic electronics,” Vijay K. Varadan, IEEE, PP. 212-215, (2003)
“Perspective of Nanotube Sensors and nanotube Actuators,” Toshio Fukuda, Fumihito Arai, Lixin dong, and Yoshiaki Imaizumi, 4^{th} IEEE Conference on nanotechnology, PP. 41-44, (2004)
“An Innovative Approach to Gas Sensing Using Carbon nanotubes Thin Films: Sensitivity, Selectivity, and Stability Response Analysis,” C. Cantalini, L. Valentini, I. Armentano, J. M. Kenny, L. Lozzi, S. Santucci, IEEE, PP. 424-427, (2003)
“Remote Sensor System using Passive SAW Sensors”, W. Buff et. al. 1994 IEEE Ultrasonics Symposium, PP. 585-588, (1994)
“Chemical Sensors for Portable, Handheld Field Instruments,” Denise Michele, et. al., IEEE Sensors Journal, 1(4), PP. 256-274, (2001)

What is claimed is:

1) A method for detecting a chemical species of interest in a volume of an atmosphere, comprising:
(a) exposing a sensor to the volume of the atmosphere, wherein any chemical species of interest that is contained in the volume of the atmosphere is capable of interacting with the nanotube forming an exposed-sensor, and the sensor comprises a nanotube filter;
(b) irradiating the exposed-sensor with microwave radiation in a chamber under a vacuum; and
(c) detecting a resonant profile of the exposed-sensor with microwave radiation.

2) The method of claim 1, further comprising selecting the nanotube filter to be a carbon nanotube (“CNT”) filter or bundle.

3) The method of claim 2, further comprising selecting the CNT filter to be a thin film of CNT's about 10² μm thick having single walled carbon nanotubes with an average diameter in the range of about 0.5 nm to about 2.5 nm.

4) The method of claim 1, further comprising selecting the nanotube filter to be buckypaper.

5) The method of claim 1, further comprising selecting the chamber to be a microwave resonant cavity.

6) The method of claim 1, further comprising functionalizing the nanotube filter by adding a functional group to the nanotube filter or bundle allow a first absorption of a first chemical structure to interact with the nanotube filter or bundle and be distinguished from a second chemical structure that does not interact with the nanotube filter.

7) The method of claim 6, further comprising selecting the first specific species to be volatile organic molecules comprising tralomethrin or allethrin.

8) The method of claim 1, further comprising functionalizing the nanotube filter or bundle and then by attaching antibodies to the functional group.

9) A method for detecting an antigen of interest in a volume of an atmosphere, comprising:
(a) dispersing antibodies on a nanotube filter, to form an antibody dispersed nanotube filter, wherein the antibodies are capable of binding the antigen of interest;
(b) exposing the antibody dispersed nanotube filter to the volume of an atmosphere, wherein any antigen of interest that is contained in the volume of the atmosphere is capable of interacting with the antibodies forming an exposed-antibody-nanotube filter;
(c) irradiating the exposed-antibody-nanotube filter with microwave radiation in a chamber under a vacuum; and
(d) detecting a resonant profile of the exposed antibody-nanotube filter with microwave radiation.

10) The method of claim 9, further comprising selecting the antigen of interest that is specific for anthrax, bubonic plague, E-coli, botulism, small pox, or other infections agents.

11) The method of claim 9, further comprising selecting the nanotube filter to be a carbon nanotube (“CNT”) filter.

12) The method of claim 11, further comprising selecting the CNT filter to be a thin film of CNT's about 10² μm thick having single walled carbon nanotubes with an average diameter in the range of about 0.5 nm to about 2.5 nm.

13) The method of claim 9, further comprising selecting the nanotube filter to be buckypaper.

14) The method of claim 9, further comprising selecting the chamber to be a microwave resonant cavity.

15) A sensor for detecting an agent or antigen of interest in a volume of an atmosphere, the sensor comprising:
(a) a nanotube filter, wherein the nanotube filter comprises single walled nanotubes arranged as a thin film; and
(b) a functional group or antibody coupled to at least one of the single walled nanotubes;
wherein the combination of a nanotube filter coupled to the functional group or antibody is capable of absorbing the agent or antigen from the volume of the atmosphere, and a spectral analysis of the sensor discerns the presence or absence of the agent or antigen of interest.

16) The sensor of claim 15, wherein the antigen of interest comprises a marker for anthrax, bubonic plague, E-coli, botulism, small pox, or other infections agents.

17) The sensor of claim 15, wherein the nanotube filter comprises a carbon nanotube (“CNT”) filter.

18) The sensor of claim 15, wherein the nanotube filter comprises a thin film about 10² μm thick comprising single walled carbon nanotubes with an average diameter in the range of about 0.5 nm to about 2.5 nm.

19) The sensor of claim 15, wherein the nanotube filter comprises buckypaper.

20) An apparatus for detecting an agent or antigen in a volume of atmosphere, the device comprising:
(a) a sensor, wherein the sensor comprises a nanotube filter having single walled nanotubes; and a functional group or antibody coupled to at least one of the single walled nanotubes, and the functional group or antibody is capable of binding the agent or antigen contained in the volume of atmosphere;
(b) a chamber for holding the sensor, wherein the chamber is capable of holding the sensor under a vacuum;
(c) a microwave source positioned to emit microwaves toward the sensor in the chamber under a vacuum; and
(d) means for analyzing spectral information of molecules bound to the sensor after the sensor has contacted the volume of atmosphere and following irradiation of the sensor with microwaves.

21) The apparatus of claim 20, wherein the antigen comprises a marker for anthrax, bubonic plague, E-coli, botulism, small pox, or other infections agents.

22) The apparatus of claim 20, wherein the nanotube filter comprises a carbon nanotube (“CNT”) filter arranged as a thin film.

23) The apparatus of claim 20, wherein the nanotube filter comprises a thin film about 10² μm thick comprising single walled carbon nanotubes with an average diameter in the range of about 0.5 nm to about 2.5 nm.

24) The apparatus of claim 20, wherein the nanotube filter comprises buckypaper.

25) The apparatus of claim 20, wherein the chamber is comprises a microwave resonant cavity.

26) The apparatus of claim 20, wherein the microwave source comprises a klystron or microwave emitting diodes.
